(19) United States
(12) Patent Application Publication
(10) Pub. No.: US 2012/0189060 A1
(43) Pub. Date: Jul. 26, 2012

(54) APPARATUS AND METHOD FOR ENCODING AND DECODING MOTION INFORMATION AND DISPARITY INFORMATION

(75) Inventors: Jin Young LEE, Ansan-si (KR); Ho Cheon WEY, Seongnam-si (KR); Kwang Hoon SOHN, Seoul (KR); Jung Dong SEO, Namyangiu-si (KR); Seung Chul RYU, Buksam-eup (KR); Dong Hyun KIM, Seoul (KR)

(73) Assignees: INDUSTRY-ACADEMIC COOPERATION FOUNDATION, YONSEI UNIVERSITY, Seoul (KR); SAMSUNG ELECTRONICS CO., LTD., Suwon-si (KR)

(21) Appl. No.: 13/352,795

(22) Filed: Jan. 18, 2012

Related U.S. Application Data
(60) Provisional application No. 61/434,606, filed on Jan. 20, 2011.

(30) Foreign Application Priority Data
Feb. 23, 2011 (KR) 10-2011-0015956

(51) Int. Cl. H04N 7/32

(52) U.S. Cl. 375/240.16; 375/E07.123

(57) ABSTRACT

An apparatus and method for encoding and de1/5/2012coding motion information and disparity information are provided. The apparatus may extract a vector from peripheral blocks of a current block, which is a vector of the same type as a vector used for predicting and compensating the current block, and perform prediction and compensation of the current block using the extracted vector.

### CROSS-REFERENCE TO RELATED APPLICATIONS

This application claims the benefit of Korean Patent Application No. 10-2011-0015956 filed on Feb. 23, 2011 in the Korean Intellectual Property Office, and claims the benefit of U.S. Provisional Application No. 61/434,606 filed on Jan. 20, 2011 in the United States Patent and Trademark Office, the disclosures of both of which are incorporated herein by reference.

### BACKGROUND

1. Field

Example embodiments of the following description relate to an apparatus and method for encoding and decoding motion information and disparity information, capable of predicting and compensating a current block using a vector of the same type as a vector used for predicting and compensating the current block.

2. Description of the Related Art

A stereoscopic image refers to a 3-dimensional (3D) image that supplies shape information on both depth and space of an image. Whereas a stereo image supplies images of different views respectively to left and right eyes of a viewer, the stereoscopic image is seen as if viewed from different directions as a viewer varies his or her point of view. Therefore, images taken in many different views are necessary to generate the stereoscopic image.

The images of different views for generating the stereoscopic image have a great amount of data. Considering the network infrastructure, a terrestrial bandwidth, and the like, it is almost infeasible to embody the stereoscopic image from the images, even though the images are compressed by an encoding apparatus optimized for single-view video coding, such as moving picture expert group (MPEG)-2 and H.264/AVC.

However, images taken from different views of the viewer are interrelated and therefore contain redundant information. Therefore, the amount of data to be transmitted may be reduced by an encoding apparatus optimized for a multiview image, capable of removing redundancy among the views.

Accordingly, there is a need for a new apparatus capable of encoding and decoding multiview video optimized for generation of a stereoscopic image and a method for efficiently encoding motion information and disparity information is especially necessary.

### SUMMARY

The foregoing and/or other aspects are achieved by providing an image processing apparatus including a vector extraction unit to extract a vector of the same type as a vector used in predicting and compensating a current block, from peripheral blocks of the current block; and a prediction and compensation unit to predict and compensate the current block using the extracted vector.

The image processing apparatus may further include a virtual vector generation unit to generate a virtual vector of the same type as the vector used in predicting and compensating the current block when the peripheral blocks do not have the vector of the same type as the vector used in prediction and compensation of the current block.

The image processing apparatus may further include a direct mode selection unit to select any one of an intra-view direct mode or first direct mode that determines images within one view as the reference images, and an inter-view direct mode or second direct mode that determines images between views as the reference images, when prediction and compensation of the current block is performed according to a direct mode.

The foregoing and/or other aspects are achieved by providing an image processing method including extracting a vector of the same type as a vector used in predicting and compensating a current block, from peripheral blocks of the current block; and predicting and compensating the current block using the extracted vector.

The image processing method may further include generating a virtual vector of the same type as a vector used in predicting and compensating the current block when the peripheral blocks do not have the vector of the same type as the vector used in prediction and compensation of the current block.

The image processing method may further include selecting any one of a the first direct mode and a the second direct mode when prediction and compensation of the current block is performed according to a direct mode.

Additional aspects, features, and/or advantages of example embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the example embodiments, taken in conjunction with the accompanying drawings of which:

FIG. 1 illustrates a block diagram of an image processing apparatus according to example embodiments;

FIG. 2 illustrates a view showing a structure of multiview video according to example embodiments;

FIG. 3 illustrates a view of a reference image used for encoding a current block, according to example embodiments;

FIG. 4 illustrates a view showing a multiview video encoding apparatus based on an input signal of moving picture expert group-multiview video coding (MPEG-MVC), according to example embodiments;

FIG. 5 illustrates a view showing a multiview video encoding apparatus based on an input signal of an MPEG-3 dimensional video (3DV), according to example embodiments;

FIG. 6 illustrates a view showing a multiview video decoding apparatus based on an input signal of an MPEG-MVC, according to example embodiments;

FIG. 7 illustrates a view showing a multiview video decoding apparatus based on an input signal of an MPEG-3DV, according to example embodiments;

FIG. 8 illustrates a view showing a process of extracting a vector for predicting and compensating motion and disparity, according to example embodiments;

FIG. 9 illustrates a view showing a process of generating a disparity vector from depth information, according to example embodiments;

FIG. 10 illustrates a view showing a process of selecting an intra-view direct mode or first direct mode and an inter-view direct mode or second direct mode, according to example embodiments; and

FIG. 11 illustrates a flowchart showing an image processing method according to example embodiments.

### DETAILED DESCRIPTION

Reference will now be made in detail to example embodiments, examples of which are illustrated in the accompanying drawings, wherein like reference numerals refer to the like elements throughout. Example embodiments are described below to explain the present disclosure by referring to the figures.

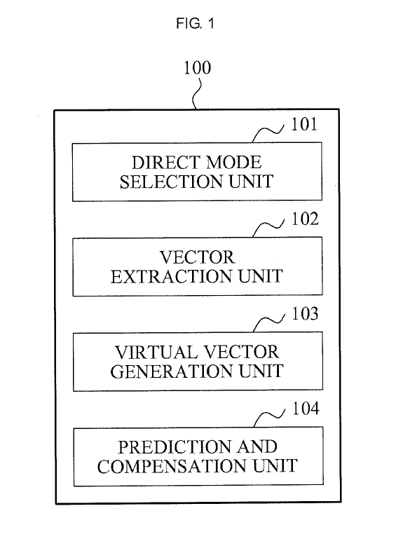

FIG. 1 illustrates a block diagram of an image processing apparatus 100 according to example embodiments.

Referring to FIG. 1, the image processing apparatus 100, which may be a computer, may include a vector extraction unit 102 and a prediction and compensation unit 104. The image processing apparatus 100 may further include a direct mode selection unit 101. In addition, the image processing apparatus 100 may further include a virtual vector generation unit 103. According to the example embodiments, the image processing apparatus 100 may be adapted to encode or decode a motion vector and a disparity vector.

The direct mode selection unit 101 may select any one of an intra-view direct mode or first direct mode and an inter-view direct mode or second direct mode when prediction and compensation of a current block is performed according to a direct mode.

The image processing apparatus 100 may increase efficiency of encoding multiview video by applying both the direct mode and an inter mode (16×16, 16×8, 8×16, P8×8) during encoding of the motion vector and the disparity vector. Here, the image processing apparatus 100 may use the first direct mode and the second direct mode at a view P and a view B, to efficiently remove redundancy among views.

More specifically, the direct mode selection unit 101 may select any one of the first direct mode that determines images in one view as reference images and the second direct mode that determines images between views as the reference images. For example, the direct mode selection unit 101 may select a direct mode having a lower cost function from the first direct mode that determines images in one view as the reference images based on rate distortion optimization (RDO) and the second direct mode that determines images between views as the reference images. The selected direct mode may be transmitted in the form of a flag.

According to the direct mode selected by the direct mode selection unit 101, subsequent processes may use the images in one view or the images between views, as the reference images.

The vector extraction unit 102 may extract a vector from peripheral blocks of the current block, the vector of the same type as a vector used in predicting and compensating the current block. For example, when prediction and compensation of the current block is performed in the view P and the view B, the vector extraction unit 102 may extract the motion vector from the peripheral blocks of the current block. In addition, when prediction and compensation of the current block is performed in the view P and the view B, the vector extraction unit 102 may extract the disparity vector from the peripheral blocks of the current block wherein the peripheral blocks refer to blocks adjoining the current block.

When prediction and compensation of the current block is performed in a view I, the vector extraction unit 102 may extract any one motion vector by referring to the reference images which are at different distances from the current block. For example, it may be presumed that prediction and compensation of the current block is performed using two reference images at different temporal distances from a current image where the current block is located. A reference image 1 denotes an image temporally closer to one of the reference images with respect to the current image, and a reference image 2 denotes the other one. A motion vector 1 denotes a motion vector corresponding to the reference image 1, and a motion vector 2 denotes a motion vector corresponding to the reference image 2.

In this case, the vector extraction unit 102 may extract the motion vector 1 from the peripheral blocks when prediction and compensation of the current block is performed using the reference image 1. Additionally, the vector extraction unit 102 may extract the motion vector 2 from the peripheral blocks when prediction and compensation of the current block is performed using the reference image 2.

The view I may be applied when the prediction is encoded in the view. The view P may be applied when the prediction is encoded between views in one direction or encoded along a time axis. The view B may be applied when the prediction is encoded between views in both directions or encoded along the time axis.

As described above, since the motion vector and the disparity vector of the same type as the vector used in predicting and compensating the current block are predicted from the peripheral blocks of the current block, the prediction accuracy may increase. However, depending on circumstances, the peripheral blocks may not have the vector of the same type as the vector used in predicting and compensating the current block. In this case, the virtual vector generation unit 103 may generate a virtual vector of the same type as the vector used for prediction and compensation of the current block. Therefore, a virtual vector, thus-generated, may be used for predicting the motion vector and the disparity vector.

The peripheral blocks may not have the vector of the same type as the vector used for prediction and compensation of the current block in the following three cases.

In one of the three cases, the motion vector is predicted in the view I. Therefore, the virtual vector generation unit 103 may determine a normalized motion vector as the virtual vector. The normalized motion vector refers to a motion vector of which size is normalized in consideration of a distance between the current image and the reference image.

For example, the motion vector may be determined by Equation 1 below.

$${mv}_{ni} = \frac{{D}_{1}}{{D}_{2}} {mv}_{i} \qquad [ Equation 1 ]$$

wherein, mvᵢ denotes a motion vector of an i-th peripheral block, and mvₙᵢ denotes a normalized motion vector of the i-th peripheral block. D₁ denotes a distance between the current image and the reference image referred to by the current image, and D₂ denotes a distance between the current image and the reference image referred to by the i-th peripheral block. The virtual vector generation unit 103 may determine a median of the normalized motion vectors as the virtual vector.

In another case, the peripheral blocks may only have the disparity vectors during prediction and compensation of the current block. In this case, the virtual vector generation unit 103 may generate a virtual motion vector. Specifically, the virtual vector generation unit 103 may generate the virtual motion vector using intra-view information or inter-view information.

For example, the virtual vector generation unit 103 may determine the virtual motion vector as a motion vector of a block in a position corresponding to the current block in the reference image of a previous time. Here, the reference image of the previous time may be an already-encoded image. Alternatively, the virtual vector generation unit 103 may determine a zero vector as the virtual motion vector.

In the other case, the peripheral blocks may only have the motion vectors during prediction and compensation of the current block. In this case, the virtual vector generation unit 103 may generate a virtual disparity vector. For example, the virtual vector generation unit 103 may generate the virtual disparity vector using the intra-view information or depth information.

For example, the virtual vector generation unit 103 may determine the virtual disparity vector as a hierarchical global disparity vector. More specifically, the virtual vector generation unit 103 may determine one of n-number of hierarchies classified according to size of global motion information based on size of local motion information, and determine a virtual disparity vector of a non-anchor frame with reference to a scaling factor corresponding to the determined hierarchy and a disparity vector of an anchor frame. For example, according to multiview video coding (MVC), anchor frames of the view P and the view B have only the disparity vectors because only inter-view prediction encoding is performed. The virtual vector generation unit 103 determines any one of the n-number of hierarchies based on size relations between global motion information and local motion information, and then determines, as the virtual disparity vector, a result of applying the scaling factor corresponding to the one hierarchy to the disparity vector of an anchor frame block in the same position as the current block.

Here, one of the n-number of hierarchies may be selected in the following manner. In multiview video, an object closer to a camera has greater inter-view disparity than an object farther away from the camera. Based on this theory, the virtual vector generation unit 103 may determine any one global disparity vector of the n-number of hierarchies as the virtual disparity vector, using the global motion information and the local motion information.

As another example, the virtual vector generation unit 103 may determine the virtual disparity vector as a disparity information conversion vector extracted from the depth information. For example, according to a moving picture expert group-3 dimensional video (MPEG-3DV), multiview depth video is used along with multiview color video. Therefore, the virtual vector generation unit 103 may calculate the disparity vector from the depth information of the multiview depth video using a camera parameter, thereby determining the disparity vector as the virtual disparity vector.

The prediction and compensation unit 104 may perform prediction and compensation of the motion vector or the disparity vector with respect to the current block, using the vector of the same type as the vector used for predicting and compensating the current block in the peripheral blocks. When the peripheral blocks do not have the vector of the same type as the vector used for predicting and compensating the current block, the prediction and compensation unit 104 may predict and compensate the current block using the virtual vector generated by the virtual vector generation unit 103.

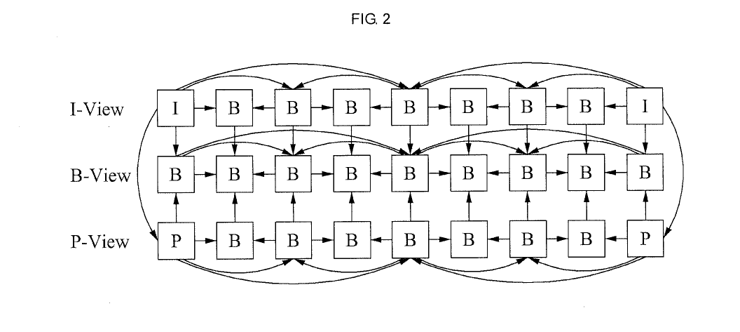

FIG. 2 illustrates a view showing a structure of multiview video according to example embodiments.

FIG. 2 shows MVC (Multiview Video Coding) which encodes input images of three views, that is, left, center, and right views, by Group of Pictures (GOP) ‘8’ structure. Since Hierarchical B picture is basically applied in a time axis and a view axis to encode the multiview image, redundancy among the images may be reduced.

According to the multiview video structure shown in FIG. 2, the multiview video encoding apparatus 100 may encode the images corresponding to the three views, by encoding a left image of the view I first and then encoding a right image of the view P and a center image of the view B sequentially.

Encoding of the left image may be performed by searching similar regions from previous images through motion estimation and removing temporal redundancy. Encoding of the right image is performed using the encoded left image as a reference image. In other words, the right image may be encoded in a manner that the temporal redundancy based on the motion estimation and inter-view redundancy based on disparity estimation are removed. The center image is encoded using both the encoded left image and right image as reference images. Accordingly, the inter-view redundancy of the center image may be removed by bidirectional disparity estimation.

Referring to FIG. 2, in the MVC, an I-view (intra coded picture) is defined as an image, such as the left image, encoded without using the reference images of other views. A P-view (predictive coded picture) is defined as an image, such as the right image, encoded by predicting the reference image of a different view in one direction. A B-view (bidirectionally predictive coded picture) is defined as an image, such as the center image, encoded by predicting the reference images of both left and right views in both directions.

The MVC frame may be classified into 6 groups according to a prediction structure. More specifically, the 6 groups includes an I-view anchor frame for intra coding, an I-view non-anchor frame for inter coding between time axes, a P-view anchor frame for unidirectional inter coding, a P-view non-anchor frame for unidirectional inter coding between views and bidirectional inter coding between time axes, a B-view anchor frame for bidirectional inter coding between views, and a B-view non-anchor frame for bidirectional inter coding between views and bidirectional inter coding between time axes.

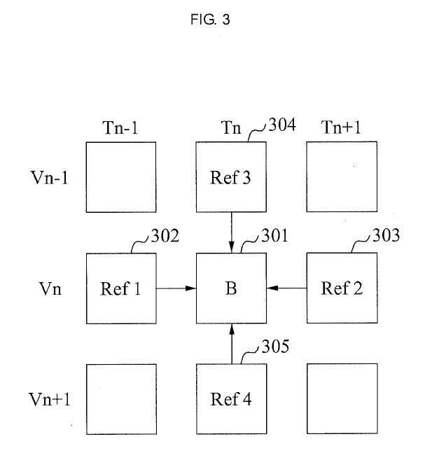

FIG. 3 illustrates a view of a reference image used for encoding a current block, according to example embodiments.

When compressing a current block located in the current frame which is a current image 301, an image processing apparatus 100 may use reference images 302 and 303 neighboring the current frame in terms of time and reference images 304 and 305 neighboring the current frame in terms of view. Specifically, the image processing apparatus 100 may search for a prediction block most similar to the current block from the reference images 302 to 305, to compress a residual signal between the current block and the prediction block. The compression mode that searches for the prediction block using the reference images may include SKIP (P Slice Only)/Direct (B Slice Only), 16×16, 16×8, 8×16, P8×8 modes.

The image processing apparatus 100 may use the reference image 302 Ref1 and the reference image 303 Ref2 in search of motion information, and use the reference image 304 Ref3 and the reference image 305 Ref4 in search of disparity information.

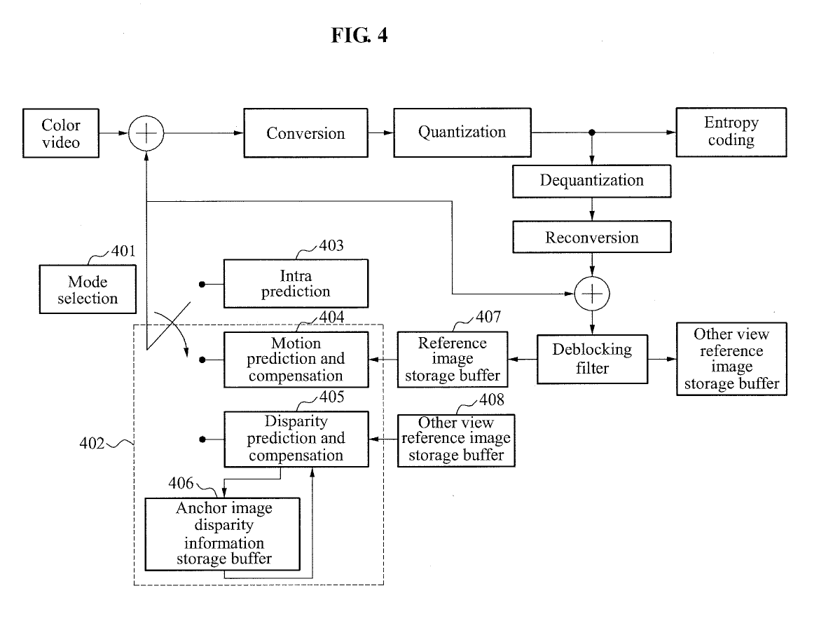

FIG. 4 illustrates a view showing a multiview video encoding apparatus based on an input signal of an MPEG-MVC, according to example embodiments.

The image processing apparatus 100 of FIG. 1 corresponds to an image processing apparatus 402 of FIG. 4. Referring to FIG. 4, the encoding apparatus may select an encoding mode with respect to color video through a mode selection unit 401. When the encoding mode is a direct mode, the mode selection unit 401 may select any one of a second direct mode and a first direct mode. The image processing apparatus 402 may perform intra-prediction 403 according to the selected encoding mode.

The image processing apparatus 402 may perform motion prediction and compensation 404 with respect to a current block of a current image, based on a reference image on a time axis, the reference image stored in a reference image storage buffer 407. In addition, the image processing apparatus 402 may perform disparity prediction and compensation with respect to the current block of the current image, based on a reference image on a view axis, the reference image stored in an other-view reference image storage buffer 408. During this, the image processing apparatus 402 may use a disparity vector stored in an anchor image disparity information storage buffer 406.

According to example embodiments, the image processing apparatus 402 may extract a vector from peripheral blocks of the current block, the vector of the same type as a vector used for prediction and compensation of the current block. That is, when motion prediction and compensation of the current block is performed in a view P and a view B, the image processing apparatus 402 may extract a motion vector from the peripheral blocks of the current block. When disparity prediction and compensation of the current block is performed in the view P and the view B, the image processing apparatus 402 may extract a disparity vector from the peripheral blocks of the current block. Thus, the image processing apparatus 402 may perform motion prediction and compensation using the motion vector or perform disparity prediction and compensation using the disparity vector.

For example, when the peripheral blocks do not have the vector of the same type of the vector used in predicting and compensating the current block, the image processing apparatus 402 may generate a virtual vector of the same type as the vector used in predicting and compensating the current block. More specifically, when the peripheral blocks have only disparity vectors during motion prediction and compensation of the current block, the image processing apparatus 402 may generate a virtual motion vector. Conversely, when the peripheral blocks have only motion vectors during disparity prediction and compensation of the current block, the image processing apparatus 402 may generate a virtual disparity vector. Accordingly, the image processing apparatus 402 may perform motion prediction and compensation or disparity prediction and compensation using the generated virtual vector.

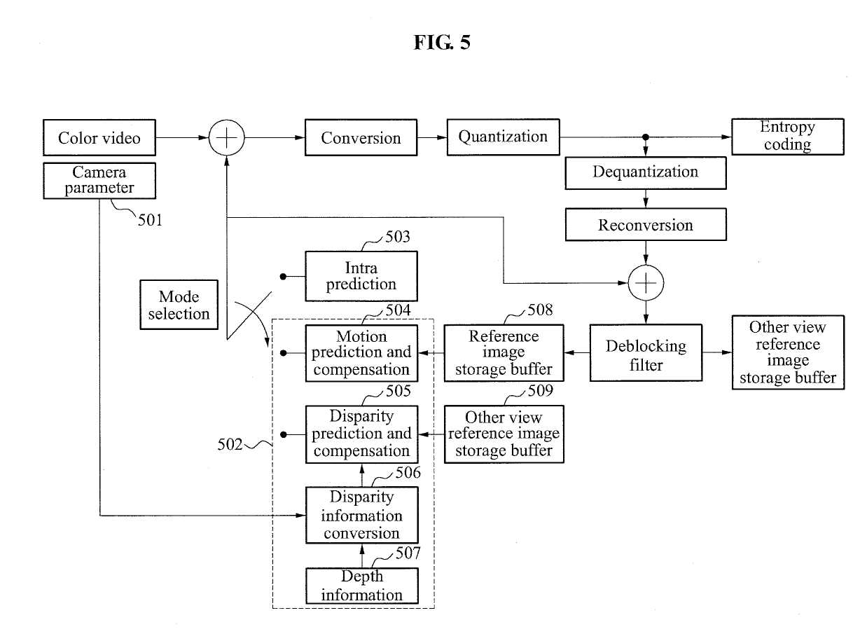

FIG. 5 illustrates a view showing a multiview video encoding apparatus based on an input signal of an MPEG-3 dimensional video (3DV), according to example embodiments.

Referring to FIG. 5, a camera parameter 501 is added in comparison to FIG. 4. When peripheral blocks have only motion vectors during disparity prediction and compensation of the current block, an image processing apparatus 502 may use the camera parameter 501 during disparity information conversion 506 from depth information 507. Since the operation of the image processing apparatus 502 is almost the same as in FIG. 4, a detailed description will be omitted.

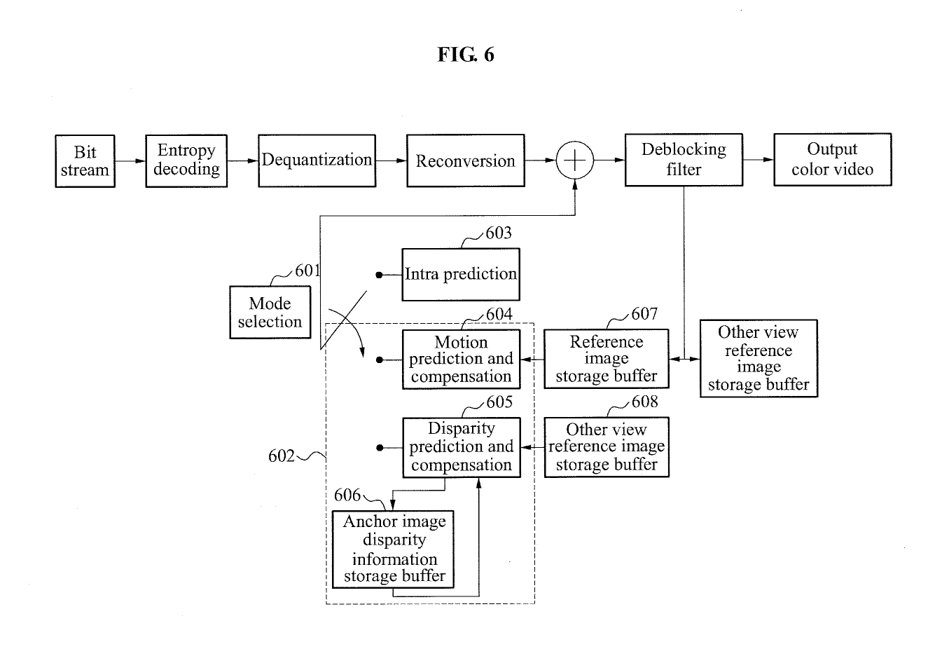

FIG. 6 illustrates a view showing a multiview video decoding apparatus based on an input signal of an MPEG-MVC, according to example embodiments.

The image processing apparatus 100 of FIG. 1 corresponds to an image processing apparatus 602 of FIG. 6. Referring to FIG. 6, the decoding apparatus may select a decoding mode with respect to color video through a mode selection unit 601. When the decoding mode is a direct mode, the mode selection unit 601 may select one of a second direct mode and a first direct mode. The image processing apparatus 602 may perform intra-prediction 603 according to the selected encoding mode.

The image processing apparatus 602 may perform motion prediction and compensation 604 with respect to a current block of a current image, based on a reference image on a time axis, the reference image stored in a reference image storage buffer 607. In addition, the image processing apparatus 602 may perform disparity prediction and compensation 605 with respect to the current block of the current image, based on a reference image on a view axis, the reference image stored in an other-view reference image storage buffer 608. During this, the image processing apparatus 602 may use a disparity vector stored in an anchor image disparity information storage buffer 606.

According to example embodiments, the image processing apparatus 602 may extract a vector from peripheral blocks of the current block, the vector of the same type as a vector used for prediction and compensation of the current block. That is, when motion prediction and compensation of the current block is performed in a view P and a view B, the image processing apparatus 602 may extract a motion vector from the peripheral blocks of the current block. When disparity prediction and compensation of the current block is performed in the view P and the view B, the image processing apparatus 602 may extract a disparity vector from the peripheral blocks of the current block. Thus, the image processing apparatus 602 may perform motion prediction and compensation using the motion vector or perform disparity prediction and compensation using the disparity vector.

For example, when the peripheral blocks do not have the vector of the same type of the vector used in predicting and compensating the current block, the image processing apparatus 602 may generate a virtual vector of the same type as the vector used in predicting and compensating the current block. More specifically, when the peripheral blocks have only disparity vectors during motion prediction and compensation of the current block, the image processing apparatus 602 may generate a virtual motion vector. Conversely, when the peripheral blocks have only motion vectors during disparity prediction and compensation of the current block, the image processing apparatus 602 may generate a virtual disparity vector. Accordingly, the image processing apparatus 602 may perform motion prediction and compensation or disparity prediction and compensation using the generated virtual vector.

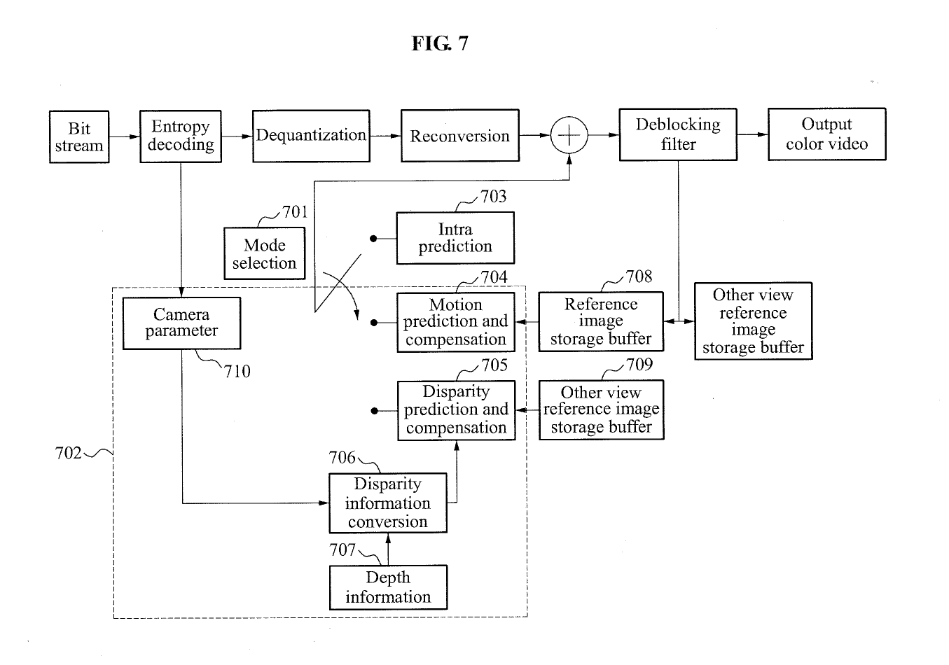

FIG. 7 illustrates a view showing a multiview video decoding apparatus based on an input signal of an MPEG-3DV, according to example embodiments.

Referring to FIG. 7, a camera parameter 710 is added in comparison to FIG. 6. When peripheral blocks have only motion vectors during disparity prediction and compensation of the current block, an image processing apparatus 702 may use the camera parameter 710 during disparity information conversion 706 from depth information 707. Since the operation of the image processing apparatus 702 is almost the same as in FIG. 6 and corresponds to apparatus 100, a detailed description will be omitted.

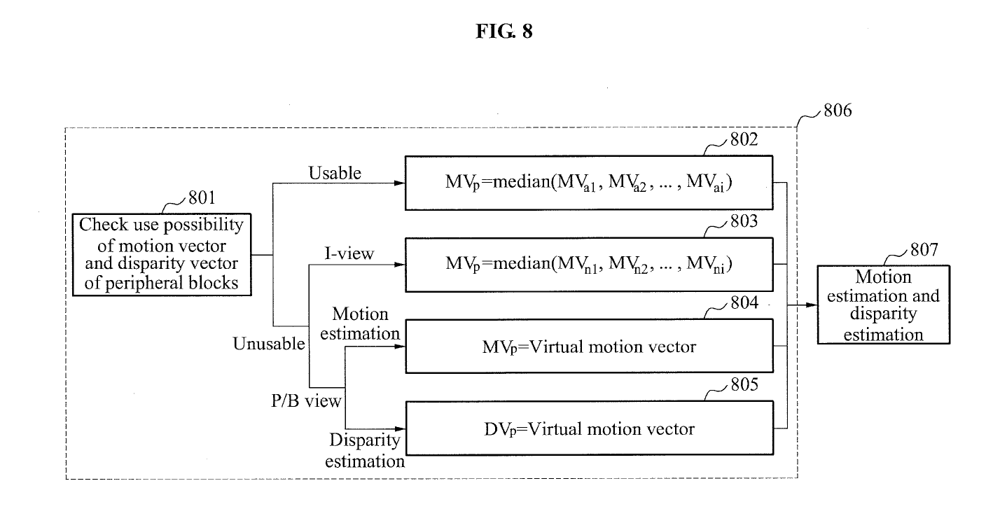

FIG. 8 illustrates a view showing a process of extracting a vector for predicting and compensating motion and disparity, according to example embodiments.

In operation 801, an image processing apparatus 806 may determine whether a vector of the same type as a vector used in predicting and compensating a current block is extractable from peripheral blocks of the current block. When the vector is determined to be extractable, the image processing apparatus 806 may calculate a median MVₚ of extracted motion vectors or a median of extracted disparity vectors DVₚ in operation 802, and perform motion prediction and compensation using the medians MVₚ and DVₚ in operation 807.

When the vector of the same type as the vector used in predicting and compensating the current block is not extractable from the peripheral blocks, the image processing apparatus 806 may calculate a median MVₚ of normalized motion vectors with respect to a view I, in operation 803. Next, in operation 807, the image processing apparatus 806 may estimate motion and disparity using the calculated medians MVₚ or DVₚ.

In operation 804, the image processing apparatus 806 may calculate a virtual motion vector MVₚ for motion estimation with respect to a view P and a view B. In addition, in operation 805, the image processing apparatus 806 may calculate a virtual disparity vector MVₚ for disparity estimation with respect to the view P and the view B.

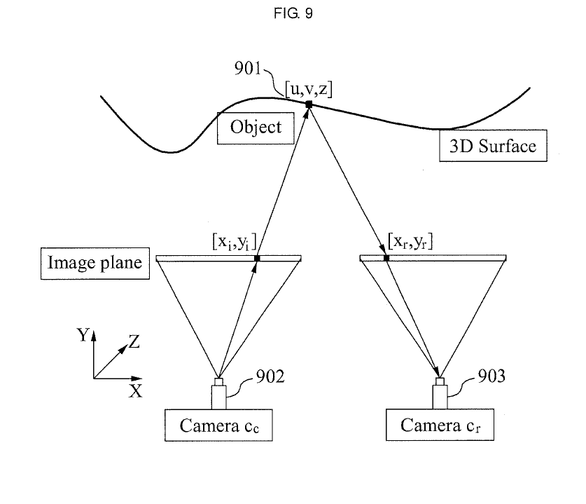

FIG. 9 illustrates a view showing a process of generating a disparity vector from depth information, according to example embodiments.

Referring to FIG. 9, the image processing apparatus 100 reflects a point (x_{c},y_{c}) of a current view of an object 901 to a world coordinate system (u,v,z) according to Equation 2 below.

[u,v,z]^{T}=R(cᵣ)A⁻¹(c_{c})[x_{c},y_{c},1]^{T}D(x_{c},y_{c},c_{c})+T(c_{c}) [Equation 2]

wherein, A(c) denotes an intrinsic camera matrix, R(c) denotes a rotation matrix of cameras 902 and 903, T(c) denotes a translation matrix of the cameras 902 and 903, and D denotes the depth information.

The image processing apparatus 100 may reflect the world coordinate system (u,v,z) to a coordinate system (xᵣ,yᵣ) of a reference image according to Equation 3 below.

[xᵣzᵣ,yᵣzᵣ,zᵣ]^{T}=A(cᵣ)R⁻¹(cᵣ){[u,v,w]^{T}−T(cᵣ)} [Equation 3]

wherein, (xᵣ,yᵣ) denotes a point corresponding to the reference image, and zᵣ denotes depth at a reference view.

Next, the image processing apparatus 100 may calculate a disparity vector (dₓ,d_{y}) according to Equation 4 below.

[dₓ,d_{y}]^{T}=[x_{c},y_{c}]^{T}−[xᵣ,yᵣ]^{T} [Equation 4]

The image processing apparatus 100 may use the disparity vector (dₓ,d_{y}) calculated by Equation 4 as a virtual disparity vector.

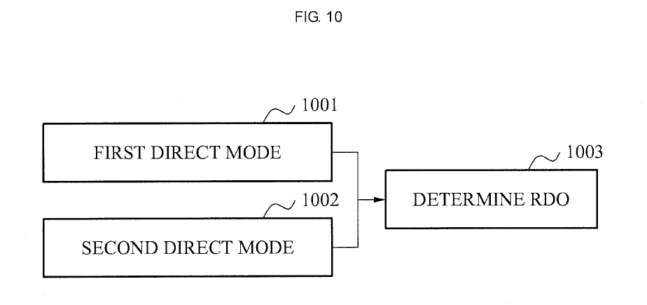

FIG. 10 illustrates a view showing a process of selecting a first direct mode and a second direct mode, according to example embodiments.

The image processing apparatus 100 may select any one of a first direct mode that determines an image in one view as a reference image, and a second direct mode that determines an image between views as the reference image. For example, a direct mode selection unit 101 may select a direct mode having a lower cost function from the first direct mode that determines images in one view as the reference images based on RDO and the second direct mode that determines images between views as the reference images. The selected direct mode may be transmitted in the form of a flag.

The cost function may be calculated by Equation 5 below.

RD Cost=SSD(s,r)+λ*R(s,r, mode) [Equation 5]

wherein, SSD denotes a sum of squares difference obtained by squaring difference values of a current block s and a predicted block r of the current image, and λ denotes a Lagrangian coefficient. R denotes a number of bits necessary when encoding a signal obtained by finding a difference between an image predicted through motion or disparity search of the current image and previous images.

According to the direct mode selected by the direct mode selection unit 101, subsequent processes may use the images in one view or the images between views, as the reference images.

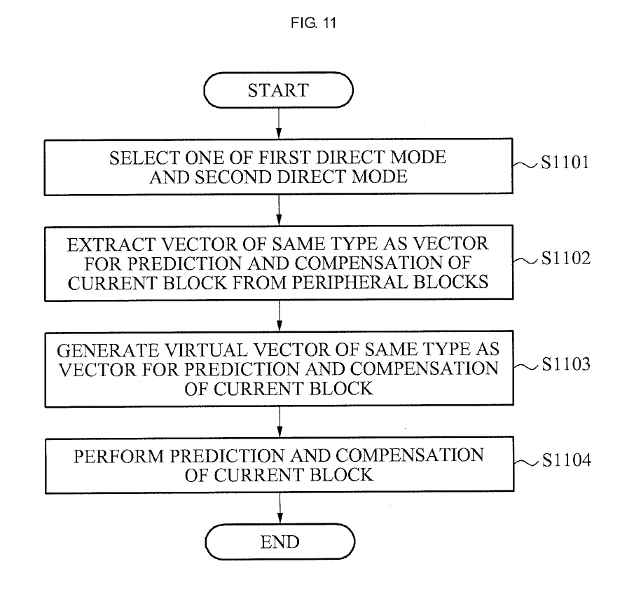

FIG. 11 illustrates a flowchart showing an image processing method according to example embodiments.

In operation S1101, the image processing apparatus 100 may select any one of a first direct mode and a second direct mode. For example, the direct mode selection unit 101 may select a direct mode having a lower cost function from the first direct mode that determines images in one view as the reference images and the second direct mode that determines images between views as the reference images.

In operation S1102, the image processing apparatus 100 may extract a vector from peripheral blocks, the vector of the same type as a vector used in predicting and compensating a current block. For example, when motion prediction and compensation of the current block is performed in a view P and a view B, the image processing apparatus 100 may extract a motion vector from the peripheral blocks of the current block. When disparity prediction and compensation of the current block is performed in the view P and the view B, the image processing apparatus 100 may extract a disparity vector.

In operation S1103, when the vector of the same type as the vector used in predicting and compensating the current block is not extractable from the peripheral blocks, the image processing apparatus 100 may generate a virtual vector of the same type as the vector used for prediction and compensation of the current block. For example, when the peripheral blocks have only disparity vectors during motion prediction and compensation of the current block, the image processing apparatus 100 may generate a virtual motion vector. Conversely, when the peripheral blocks have only motion vectors, the image processing apparatus 100 may generate a virtual disparity vector.

More specifically, when the peripheral blocks have only the disparity vectors during prediction and compensation of the current block, the image processing apparatus 100 may generate the virtual motion vector using intra-view information or inter-view information.

For example, when the peripheral blocks have only the disparity vectors during motion prediction and compensation of the current block, the image processing apparatus 100 may determine the virtual motion vector as a motion vector of a block in a position corresponding to the current block in a reference image of a previous time. As another example, when the peripheral blocks have only disparity vectors during motion prediction and compensation of the current block, the image processing apparatus 100 may determine the virtual motion vector as a motion vector of a block in a position corresponding to the current block in a reference image of a neighboring view. As a further example, when the peripheral blocks have only the disparity vectors, the image processing apparatus 100 may determine a zero vector as the virtual motion vector.

In addition, when the peripheral blocks have only the motion vectors during disparity prediction and compensation of the current block, the image processing apparatus 100 may generate the virtual disparity vector using the intra-view information or depth information. For example, the image processing apparatus 100 may determine a hierarchical global disparity vector as the virtual disparity vector.

More specifically, when the peripheral blocks have only the motion vectors during disparity prediction and compensation of the current block, the image processing apparatus 100 may determine one of n-number of hierarchies classified according to size of global motion information based on size of local motion information, and determine a virtual disparity vector of a non-anchor frame with reference to a scaling factor corresponding to the determined hierarchy and a disparity vector of an anchor frame wherein each hierarchy defines the scaling factor.

As another example, during disparity prediction and compensation of the current block, when the peripheral blocks have only the motion vectors, the image processing apparatus 100 may determine a disparity information conversion vector extracted from the depth information as the virtual disparity vector.

In operation S1104, the image processing apparatus 100 may predict and compensate the current block.

The methods according to the above-described example embodiments may be recorded in non-transitory computer-readable media including program instructions to implement various operations embodied by and executed on a computer. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts.

Although example embodiments have been shown and described, it would be appreciated by those skilled in the art that changes may be made in these example embodiments without departing from the principles and spirit of the disclosure, the scope of which is defined in the claims and their equivalents.

What is claimed is:

1. An image processing apparatus, comprising:
a vector extraction unit to extract a vector of a same type as a vector used in predicting and compensating a current block, from peripheral blocks of the current block; and
a prediction and compensation unit to predict and compensate the current block using the extracted vector.

2. The image processing apparatus of claim 1, wherein the vector extraction unit extracts a motion vector from the peripheral blocks of the current block when motion prediction and compensation of the current block is performed at a view P and a view B, and extracts a disparity vector from the peripheral blocks of the current block when disparity prediction and compensation of the current block is performed at the view P and the view B.

3. The image processing apparatus of claim 1, wherein the vector extraction unit extracts a motion vector using reference images at respectively different distances from the current block when motion prediction and compensation of the current block is performed at a view I.

4. The image processing apparatus of claim 1, further comprising:
a virtual vector generation unit to generate a virtual vector of the same type as the vector used in predicting and compensating the current block when the peripheral blocks do not have the vector of the same type as the vector used in prediction and compensation of the current block.

5. The image processing apparatus of claim 4, wherein the virtual vector generation unit generates a virtual motion vector when the peripheral blocks have only disparity vectors during motion prediction and compensation of the current block, and generates a virtual disparity vector when the peripheral blocks have only the motion vectors during disparity prediction and compensation of the current block.

6. The image processing apparatus of claim 5, wherein the virtual vector generation unit generates the virtual motion vector using intra-view information and inter-view information, when the peripheral blocks have only the disparity vectors during motion prediction and compensation of the current block.

7. The image processing apparatus of claim 6, wherein the virtual vector generation unit determines the virtual motion vector as a motion vector of a block in a position corresponding to the current block in a reference image of a previous time when the peripheral blocks have only the disparity vectors during motion prediction and compensation of the current block.

8. The image processing apparatus of claim 6, wherein the virtual vector generation unit determines the virtual motion vector as a motion vector of a block in a position corresponding to the current block in a reference image of a neighboring view when the peripheral blocks have only the disparity vectors during motion prediction and compensation of the current block.

9. The image processing apparatus of claim 6, wherein the virtual vector generation unit determines a zero vector as the virtual motion vector when the peripheral blocks have only the disparity vectors during motion prediction and compensation of the current block.

10. The image processing apparatus of claim 5, wherein the virtual vector generation unit generates the virtual disparity vector using intra-view information or depth information when the peripheral blocks have only the disparity vectors during disparity prediction and compensation of the current block.

11. The image processing apparatus of claim 10, wherein the virtual vector generation unit determines a hierarchical global disparity vector as the virtual disparity vector when the peripheral blocks have only the disparity vectors during disparity prediction and compensation of the current block.

12. The image processing apparatus of claim 11, wherein, when the peripheral blocks have only the disparity vectors during disparity prediction and compensation of the current block, the virtual vector generation unit determines one of n-number of hierarchies classified according to size of global motion information based on size of local motion information, and determines a virtual disparity vector of a non-anchor frame with reference to a scaling factor corresponding to the determined hierarchy and a disparity vector of an anchor frame.

13. The image processing apparatus of claim 10, wherein, when the peripheral blocks have only the disparity vectors during disparity prediction and compensation of the current block, the virtual vector generation unit determines the virtual disparity vector as a disparity information conversion vector extracted from the depth information.

14. The image processing apparatus of claim 1, further comprising a direct mode selection unit to select any one of a first direct mode that determines images within one view as the reference images, and a second direct mode that determines images between views as the reference images, when prediction and compensation of the current block is performed according to a direct mode.

15. The image processing apparatus of claim 14, wherein the direct mode selection unit selects a direct mode having a lower cost function from the first direct mode and the second direct mode.

16. An image processing method, comprising:
extracting a vector of a same type as a vector used in predicting and compensating a current block, from peripheral blocks of the current block; and
predicting and compensating the current block using the extracted vector.

17. The image processing method of claim 16, the extracting of the vector comprises:
extracting a motion vector from the peripheral blocks of the current block when motion prediction and compensation of the current block is performed at a view P and a view B; and
extracting a disparity vector from the peripheral blocks of the current block when disparity prediction and compensation of the current block is performed at the view P and the view B.

18. The image processing method of claim 16, wherein the extracting of the vector comprises:
extracting the motion vector using reference images at respectively different distances from the current block when motion prediction and compensation of the current block is performed at a view I.

19. The image processing method of claim 16, further comprising:
generating a virtual vector of the same type as a vector used in predicting and compensating the current block when the peripheral blocks do not have the vector of the same type as the vector used in prediction and compensation of the current block.

20. The image processing method of claim 19, wherein the generating of the virtual vector comprises:
generating a virtual motion vector when the peripheral blocks have only disparity vectors during motion prediction and compensation of the current block; and
generating a virtual disparity vector when the peripheral blocks have only motion vectors during disparity prediction and compensation of the current block.

21. The image processing method of claim 20, wherein the generating of the virtual vector comprises:
generating the virtual motion vector using intra-view information or inter-view information when the peripheral blocks have only the disparity vectors during motion prediction and compensation of the current block.

22. The image processing method of claim 21, wherein the generating of the virtual vector determines the virtual motion vector as a motion vector of a block in a position corresponding to the current block in a reference image of a previous time when the peripheral blocks have only the disparity vectors during motion prediction and compensation of the current block.

23. The image processing method of claim 21, wherein the generating of the virtual vector determines the virtual motion vector as a motion vector of a block in a position corresponding to the current block in a reference image of a neighboring view when the peripheral blocks have only the disparity vectors during motion prediction and compensation of the current block.

24. The image processing method of claim 21, wherein the generating of the virtual vector determines a zero vector as the virtual motion vector when the peripheral blocks only have the disparity vectors during motion prediction and compensation of the current block.

25. The image processing method of claim 20, wherein the generating of the virtual vector generates the virtual disparity vector using intra-view information or depth information when the peripheral blocks only have the disparity vectors during disparity prediction and compensation of the current block.

26. The image processing method of claim 25, wherein the generating of the virtual vector determines a hierarchical global disparity vector as the virtual disparity vector when the peripheral blocks have only the disparity vectors during disparity prediction and compensation of the current block.

27. The image processing method of claim 26, wherein, when the peripheral blocks have only the disparity vectors during disparity prediction and compensation of the current block, the generating of the virtual vector determines one of n-number of hierarchies classified according to size of global motion information based on size of local motion information, and determines a virtual disparity vector of a non-anchor frame with reference to a scaling factor corresponding to the determined hierarchy and a disparity vector of an anchor frame.

28. The image processing method of claim 25, wherein, when the peripheral blocks have only the disparity vectors during disparity prediction and compensation of the current block, the generating of the virtual vector determines a disparity information conversion vector extracted from the depth information as the virtual disparity vector.

29. The image processing method of claim 16, further comprising selecting any one of a first direct mode and a second direct mode when prediction and compensation of the current block is performed according to a direct mode.

30. The image processing method of claim 29, wherein the selecting of any one of the first direct mode and the second direct mode selects a direct mode having a lower cost function from the first direct mode that determines images in one view as reference images and the second direct mode that determines images between views as the reference images.

31. A non-transitory computer readable recording medium storing a program to cause a computer to implement a method of extracting a vector of a same type as a vector used in predicting and compensating a current block, from peripheral blocks of the current block; and predicting and compensating the current block using the extracted vector.

32. An image processing method, comprising:
producing a vector of a same type as a vector used in predicting and compensating a current block, from peripheral blocks of the current block by extracting a vector when the vector of the same type exists in the peripheral blocks and generating a virtual vector of the same type when the vector of the same type does not exist in the peripheral blocks; and
predicting and compensating the current block using the extracted vector.

33. The image processing method of claim 32, wherein the vector comprises a motion vector when motion prediction and compensation is performed and the vector comprises a disparity vector when disparity prediction and compensation is performed.
